(19) United States
(12) Patent Application Publication
(10) Pub. No.: US 2021/0063617 A1
(43) Pub. Date: Mar. 4, 2021

(54) PRISM FOR OPTICAL IMAGING SYSTEM

(71) Applicant: Samsung Electro-Mechanics Co., Ltd., Suwon-si (KR)

(72) Inventors: Dong Shin YANG, Suwon-si (KR); Sot Eum SEO, Suwon-si (KR); Ju Sung PARK, Suwon-si (KR)

(73) Assignee: Samsung Electro-Mechanics Co., Ltd., Suwon-si (KR)

(21) Appl. No.: 17/005,867

(22) Filed: Aug. 28, 2020

(30) Foreign Application Priority Data
Aug. 30, 2019 (KR) 10-2019-0107439

(51) Int. Cl. G02B 5/04; G02B 1/11; G02B 5/20

(52) U.S. Cl. CPC G02B 5/04; G02B 5/208; G02B 1/11

(57) ABSTRACT

A prism for an optical imaging system includes an incident surface, an emitting surface from which light is emitted, and a reflective surface reflecting light incident through the incident surface to the emitting surface, wherein at least one connection portion of the incident surface and the emitting surface is chamfered to form a surface.

### CROSS-REFERENCE TO RELATED APPLICATIONS

This application claims the benefit under 35 USC 119(a) of Korean Patent Application No. 10-2019-0107439 filed on Aug. 30, 2019, in the Korean Intellectual Property Office, the entire disclosure of which is incorporated herein by reference for all purposes.

### BACKGROUND

### 1. Field

The present disclosure relates to a prism configured to change an optical path of an optical imaging system.

### 2. Description of the Background

An optical imaging system may be mounted on a portable terminal. However, since a portable terminal in a form of a smartphone has a generally thinned structure, it is not easy to mount an optical imaging system having a long focal length thereon. A curved optical imaging system is configured to solve this problem. For example, the curved optical imaging system may use a prism to dispose a plurality of lenses in a longitudinal direction of the portable terminal. However, the prism provided with the curved optical imaging system may be easily damaged by external impacts, since a corner portion may be formed to have an acute shape.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a prism for an optical imaging system includes an incident surface, an emitting surface from which light is emitted, and a reflective surface reflecting light incident through the incident surface to the emitting surface, wherein at least one connection portion of the incident surface and the emitting surface is chamfered to form a surface.

The at least one connection portion may include a first connection surface, to which the incident surface and the emitting surface are connected, formed to have an obtuse angle with respect to the incident surface and the emitting surface, respectively.

The at least one connection portion may include a second connection surface, at which one or more of the incident surface and the reflective surface are connected and the emitting surface and the reflective surface are connected, formed to have an obtuse angle with respect to the reflective surface.

The incident surface and the emitting surface may each be configured to have a wavefront aberration different from that of the reflective surface.

The wavefront aberration of the incident surface and the wavefront aberration of the emitting surface may each be greater than a reflective aberration of the reflective surface.

An antireflective layer may be formed on the incident surface and the emitting surface.

An antireflective layer and an infrared blocking layer may be formed on the reflective surface.

The surface of the connection portion may include one or more of a light shielding paint, a light shielding film, and a light-scattering roughness to prevent a flare phenomenon.

The incident surface may include a first light transmitting region capable of transmitting incident light and a first light shielding region capable of blocking incident light.

The emitting surface may include a second light transmitting region capable of transmitting incident light and a second light shielding region capable of blocking incident light.

The second light transmitting region may be formed to be smaller than the first light transmitting region.

The at least one connection portion may include a third connection surface connecting the incident surface and a side surface, and configured to have an obtuse angle with respect to the incident surface.

The at least one connection portion may include a fourth connection surface connecting the emitting surface and a side surface, and configured to have an obtuse angle with respect to the emitting surface.

In another general aspect, an optical imaging system includes a lens comprising an effective region to refract incident light on an optical path reflected from an object, and a prism configured to bend the optical path and including an incident surface, a reflective surface, a light emitting surface, and two side surfaces spaced apart from each other by the incident surface, the reflective surface, and the light emitting surface, wherein one or more corners of the prism have a chamfered region, and wherein the chamfered region includes one or more of a light shielding film, a light shielding paint, and a light-scattering roughness.

The two side surfaces may include one or more of a light shielding film, a light shielding paint, and a light-scattering roughness.

One or more of the incident surface and the light emitting surface may include a light shielding region capable of blocking incident light and a light transmitting region capable of transmitting incident light, and the light shielding region may surround the light transmitting region.

The incident surface and the emitting surface may each be configured to have a wavefront aberration different from that of the reflective surface.

The incident surface, the light emitting surface, and the reflective surface may have a predetermined wavefront aberration.

In another general aspect, a prism for an optical imaging system includes an incident surface, a reflective surface, and a light emitting surface, wherein one or more of the incident surface and the light emitting surface includes a light shielding region capable of blocking incident light and a light transmitting region capable of transmitting incident light, wherein one or more corners of the prism where any two of the incident surface, the reflective surface, and the light emitting surface meet, includes a chamfered region having a light-blocking or light-scattering surface.

The prism may include a rectangular parallelepiped bisected in a diagonal direction, the incident surface, the reflective surface, and the light emitting surface may be rectangular, and two sides spaced apart from each other by the incident surface, the reflective surface, and the light emitting surface may be triangular and each of the two sides may have a light-blocking or light-scattering surface.

Other features and aspects will be apparent from the following detailed description, the drawings, and the claims.

### BRIEF DESCRIPTION OF DRAWINGS

A perspective view of a prism for an optical imaging system is shown in (a) of FIG. 1 and a cross section view of a prism for an optical imaging system is shown in (b) of FIG. 1 according to a first embodiment of the present disclosure.

A perspective view of a prism for an optical imaging system is shown in (a) of FIG. 2 and a cross section view of a prism for an optical imaging system is shown in (b) of FIG. 2 according to a second embodiment of the present disclosure.

FIG. 3 is a perspective view of a prism for an optical imaging system according to a third embodiment of the present disclosure.

FIG. 4 is a perspective view of a prism for an optical imaging system according to a fourth embodiment of the present disclosure.

FIG. 5 is a perspective view of a prism for an optical imaging system according to a fifth embodiment of the present disclosure.

FIG. 6 is a perspective view of a prism for an optical imaging system according to a sixth embodiment of the present disclosure.

FIG. 7 is a perspective view of a prism for an optical imaging system according to a seventh embodiment of the present disclosure.

FIG. 8 is a perspective view of a prism for an optical imaging system according to an eighth embodiment of the present disclosure.

A perspective view of a prism for an optical imaging system is shown in (a) and (b) of FIG. 9 according to a ninth embodiment of the present disclosure.

FIG. 10 is a first modification example of the prism of FIG. 9.

FIG. 11 is a second modification example of the prism of FIG. 9.

FIG. 12 is a third modification example of the prism of FIG. 9.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween. As used herein “portion” of an element may include the whole element or less than the whole element.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may be also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

The features of the examples described herein may be combined in various ways as will be apparent after an understanding of this disclosure. Further, although the examples described herein have a variety of configurations, other configurations are possible as will be apparent after an understanding of this disclosure.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

An aspect of the present disclosure is to provide a prism for an optical imaging system capable of reducing a phenomenon in which a part or all of a prism is damaged by external impacts.

A curved optical imaging system includes a prism for reflecting or bending an optical path. The prism has a rectangular parallelepiped or cubic shape bisected in a diagonal direction. Since the prism has a sharp corner, it may be easily damaged by impacts. In particular, a corner connecting the incident surface and the reflective surface and a corner connecting the light emitting surface and the reflective surface are very sharp, so they may be damaged by impacts and interfere with the reflection of light through the reflective surface.

An aspect of the present disclosure may solve the above problems, and reduce a phenomenon in which the prism is damaged by impact and a reflection function of the prism is deteriorated. In addition, in the present disclosure, a light shielding member may be formed in a portion in which light is not incident or emitted to improve reflection performance of the prism. The light shielding member may be partially formed on the prism. In addition, the light shielding member may be partially formed in a portion of the prism to have a predetermined ratio with respect to a total surface area of the prism. For example, an area in which the light shielding member is formed may be in a range of 15 to 22% of the total surface area of the prism.

A prism for an optical imaging system according to a first embodiment will be described with reference to (a) and (b) of FIG. 1.

A prism 101 according to the present embodiment generally has a rectangular parallelepiped or a cubic shape bisected in a diagonal direction. The prism 101 includes three surfaces of a square shape and two surfaces of a triangular shape. For example, an incident surface 110, a light emitting surface 120, and a reflective surface 130 of the prism 101 are rectangular, and both side surfaces of the prism 101 are triangular.

The prism 101 may be made of a predetermined material. For example, the prism 101 may be made of a plastic material to facilitate manufacturing and processing. However, the material of the prism 101 is not limited to plastic. For example, the prism 101 may be made of a glass material within a range that can be manufactured and in a size that can be mounted on a portable terminal.

The prism 101 according to the present embodiment may be manufactured in a predetermined process. For example, the prism 101 may be manufactured by injection molding within a reliable range of processing quality. Since the prism 101 manufactured as described above can omit a separate polishing process, the manufacturing process of the prism 101 can be simplified.

The prism 101 may be formed to have a predetermined wavefront aberration. For example, the incident surface 110 and the light emitting surface 120 of the prism 101 may be formed to have a wavefront aberration of ½λ, and the reflective surface 130 of the prism 101 may be formed to have a wavefront aberration of ¼λ. The prism 101 configured as described above can reduce aberrations that may be caused by bending an optical path.

The prism 101 may include a plurality of coating layers. For example, anti-reflective layers 210 and 220 may be formed on the incident surface 110 and the light emitting surface 120 of the prism 101. As another example, the anti-reflective layer and an infrared blocking layer 230 may be integrally formed on the reflective surface 130 of the prism 101.

The prism 101 may include one or more chamfered regions. For example, a portion 112 (connection portion) at which the incident surface 110 and the light emitting surface 120 are connected is formed to have a predetermined first angle θ1 with respect to the incident surface 110 and the light emitting surface 120. The portion 112 may be processed to be obtuse with respect to the incident surface 110 or the light emitting surface 120. In the present embodiment, the first angle θ1 may be an angle of 135 degrees.

The portion 112 may be formed so as not to cause a flare phenomenon. For example, the portion 112 may include a light-blocking or light-scattering surface. As an example, a light shielding film may be attached to the portion 112 or the portion 112 may be painted with a light shielding paint. As another example, the portion 112 may be processed into a form having a roughness so that scattering of light can be achieved.

Next, another form of the prism for an optical imaging system according to the present disclosure will be described. For reference, the same or similar configuration to the above-described embodiment in the following description uses the same reference numerals as the above-described embodiment, and further detailed description of the corresponding component may be omitted.

A prism for an optical imaging system according to a second embodiment will be described with reference to (a) and (b) of FIG. 2.

A prism for an optical imaging system according to a second embodiment will be described with reference to (a) and (b) of FIG. 2. The prism 102 includes three surfaces of a square shape and two surfaces of a triangular shape. For example, an incident surface 110, a light emitting surface 120, and a reflective surface 130 of the prism 102 are rectangular, and both side surfaces of the prism 102 are triangular.

The prism 102 according to the present embodiment includes a plurality of chamfered regions. For example, a portion 131 to which the incident surface 110 and the reflective surface 130 are connected, and a portion 132 to which the reflective surface 130 and the light emitting surface 120 are connected are formed to have predetermined second and third angles θ2 and θ3. The portions 131 and 132 may be processed to be obtuse with respect to reflective surface 130 as in (a) and (b) of FIG. 2. For example, the second angle θ2 formed by the portions 131 and 132 and the incident surface 110 and the light emitting surface 120 may be 90 degrees. As another example, the third angle θ3 formed by the portions 131 and 132 and reflective surface 130 may be 135 degrees.

The portions 131 and 132 may be formed not to cause a flare phenomenon. As an example, a light shielding film may be attached to the portions 131 and 132 or the portions 131 and 132 may be painted with a light shielding paint. As another example, the portions 131 and 132 may be processed into a form having a roughness so that scattering of light can be achieved.

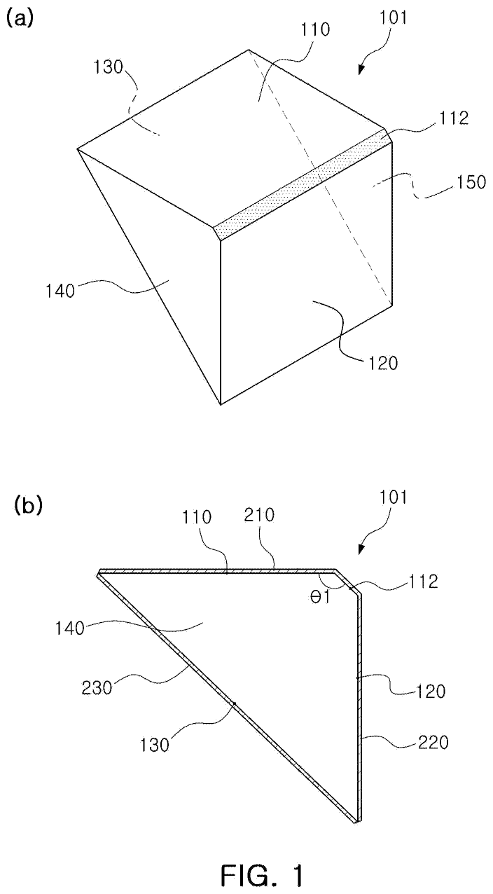

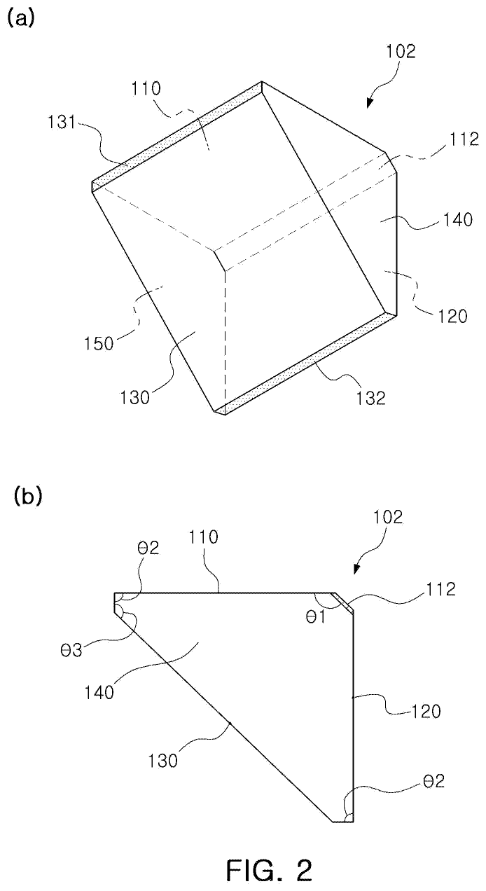

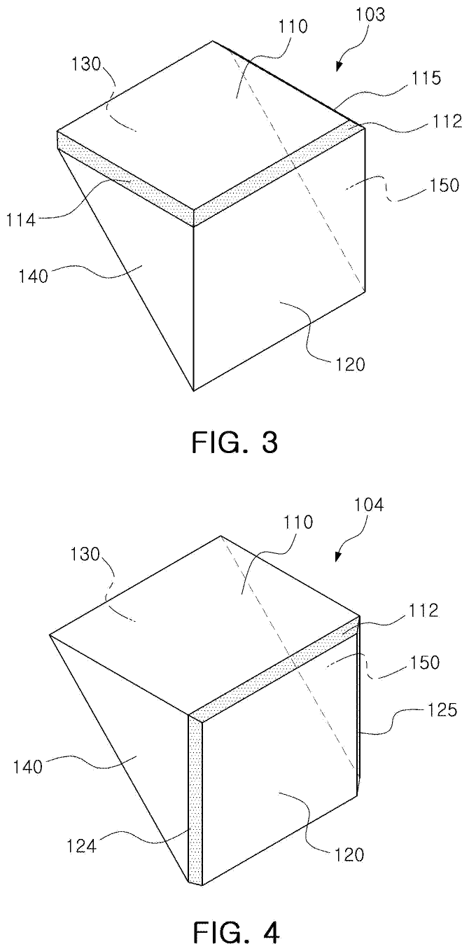

A prism for an optical imaging system according to a third embodiment will be described with reference to FIG. 3.

A prism 103 according to the present embodiment has a rectangular parallelepiped or a cubic shape bisected in a diagonal direction. The prism 103 includes three surfaces of a square shape and two surfaces of a triangular shape. For example, an incident surface 110, a light emitting surface 120, and a reflective surface 130 of the prism 103 are rectangular, and both side surfaces of the prism 103 are triangular.

The prism 103 according to the present embodiment includes a plurality of chamfered regions. For example, as shown in FIG. 3, a portion 114 at which an incident surface 110 and a first side surface 140 are connected and a portion 115 at which an incident surface 110 and a second side surface 150 are connected may be processed to be obtuse with respect to the incident surface 110.

The portions 114 and 115 may be formed not to cause a flare phenomenon. For example, a light shielding film may be attached to the portions 114 and 115 or the portions 114 and 115 may be painted with a light shielding paint. As another example, the portions 114 and 115 may be processed into a form having a roughness so that scattering of light can be achieved.

A prism for an optical imaging system according to a fourth embodiment will be described with reference to FIG. 4.

A prism 104 according to the present embodiment has a rectangular parallelepiped or a cubic shape bisected in a diagonal direction. The prism 104 includes three surfaces of a square shape and two surfaces of a triangular shape. For example, an incident surface 110, a light emitting surface 120, and a reflective surface 130 of the prism 104 are rectangular, and both side surfaces of the prism 104 are triangular.

The prism 104 according to the present embodiment includes a plurality of chamfered regions. For example, as shown in FIG. 4, a portion 124 where a light emitting surface 120 and a first side surface 140 are connected and a portion 125 at which a light emitting surface 120 and a second side surface 150 are connected may be processed to be obtuse with respect to the light emitting surface 120.

The portions 124 and 125 may be formed not to cause a flare phenomenon. As an example, a light shielding film may be attached to the portions 124 and 125 or the portions 124 and 125 may be painted with a light shielding paint. As another example, the portions 124 and 125 may be processed into a form having a roughness so that scattering of light can be achieved.

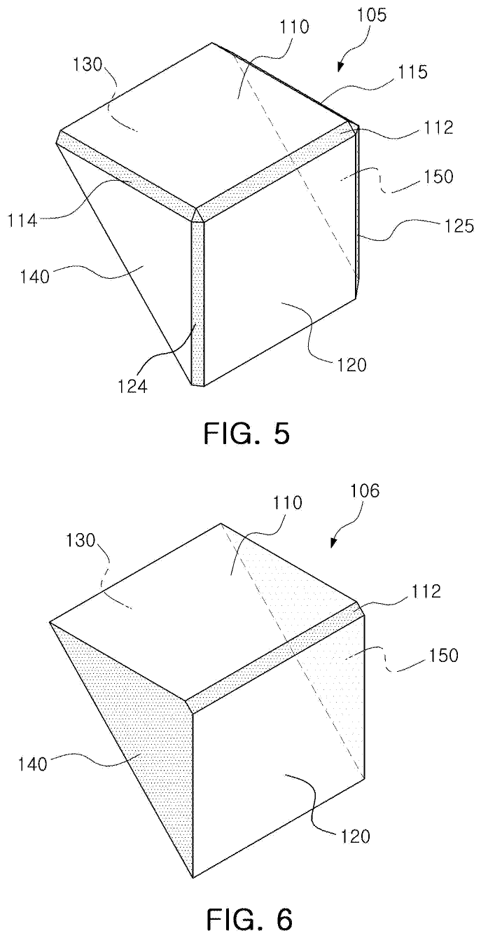

A prism for an optical imaging system according to a fifth embodiment will be described with reference to FIG. 5.

A prism 105 according to the present embodiment has a rectangular parallelepiped or a cubic shape bisected in a diagonal direction. The prism 105 includes three surfaces of a square shape and two surfaces of a triangular shape. For example, an incident surface 110, a light emitting surface 120, and a reflective surface 130 of the prism 105 are rectangular, and both side surfaces of the prism 105 are triangular.

The prism 105 according to the present embodiment includes a plurality of chamfered regions. For example, a portion 114 where an incident surface 110 and a first side surface 140 are connected and a portion 115 at which an incident surface 110 and a second side surface 150 are connected may be processed to be obtuse with respect to the incident surface 110. In addition, a portion 124 where a light emitting surface 120 and a first side surface 140 are connected and a portion 125 where a light emitting surface 120 and a second side surface 150 are connected may be processed to be obtuse with respect to the light emitting surface 120.

The portions 114, 115, 124, and 125 may be formed not to cause a flare phenomenon. As an example, a light shielding film may be attached to the portions 114, 115, 124, and 125 or the portions 114, 115, 124, and 125 may be painted with a light shielding paint. As another example, the portions 114, 115, 124, and 125 may be processed into a form having a roughness so that scattering of light can be achieved.

A prism for an optical imaging system according to a sixth embodiment will be described with reference to FIG. 6.

A prism 106 according to the present embodiment has a rectangular parallelepiped or a cubic shape bisected in a diagonal direction. The prism 106 includes three surfaces of a square shape and two surfaces of a triangular shape. For example, an incident surface 110, a light emitting surface 120, and a reflective surface 130 of the prism 106 are rectangular, and both side surfaces of the prism 106 are triangular.

The prism 106 according to the present embodiment may include one or more chamfered regions. For example, as shown in FIG. 6, a portion 112 at which an incident surface 110 and a light emitting surface 120 are connected may be processed to be obtuse with respect to the incident surface 110 or the light emitting surface 120.

The portion 112 may be formed not to cause a flare phenomenon. As an example, a light shielding film may be attached to the portion 112 or the portion 112 may be painted with a light shielding paint. As another example, the portion 112 may be processed into a form having a roughness so that scattering of light can be achieved.

In addition, the prism 106 according to the present embodiment may be configured to block incident light through a side surface. As an example, a light shielding film may be attached to a first side surface 140 and a second side surface 150 of the prism 106 or a first side surface 140 and a second side surface 150 of the prism 106 may be painted with a light shielding paint. As another example, the first side surface 140 and the second side surface 150 of the prism 106 may be processed in a form having a roughness so that scattering of light can be achieved.

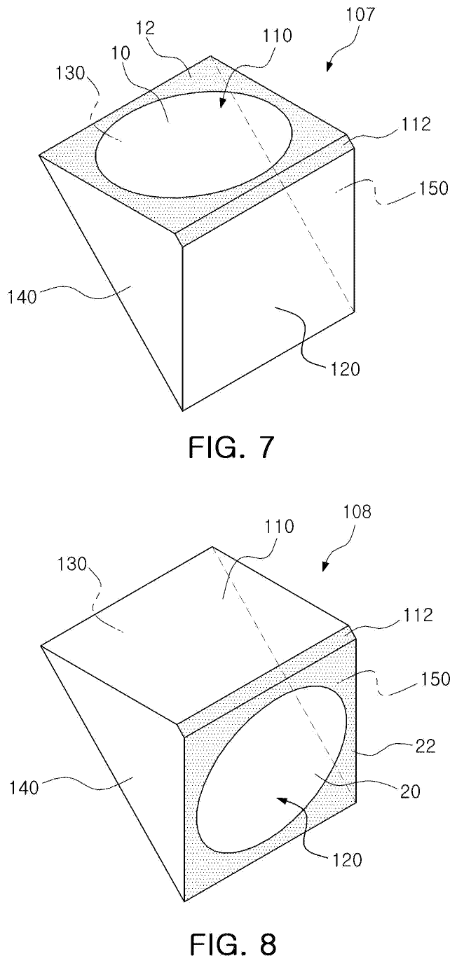

A prism for an optical imaging system will be described with reference to FIG. 7.

A prism 107 according to the present embodiment has a rectangular parallelepiped or a cubic shape bisected in a diagonal direction. The prism 107 includes three surfaces of a square shape and two surfaces of a triangular shape. For example, an incident surface 110, a light emitting surface 120, and a reflective surface 130 of the prism 107 are rectangular, and both side surfaces of the prism 106 are triangular.

The prism 107 according to the present embodiment may include one or more chamfered regions. For example, as shown in FIG. 7, a portion 112 where an incident surface 110 and a light emitting surface 120 are connected may be processed to be obtuse with respect to the incident surface 110 or the light emitting surface 120.

The portion 112 may be formed not to cause a flare phenomenon. As an example, a light shielding film may be attached to the portion 112 or the portion 112 may be painted with a light shielding paint. As another example, the portion 112 may be processed in a form having a roughness so that scattering of light can be achieved.

In addition, the prism 107 according to the present embodiment may be configured to limit an incident region of light. For example, as shown in FIG. 7, the incident surface 110 of the prism 107 may include a light transmitting region 10 capable of transmitting incident light and a light shielding region 12 capable of blocking incident light.

The light transmitting region 10 may be formed to be substantially the same or similar to the cross-sectional shape of a lens constituting the optical imaging system. Specifically, the light transmitting region 10 may be formed to be the same or similar to an effective region of a lens (hereinafter, referred to as a first lens) disposed closest to an object side in the optical imaging system. As an example, if the effective region of the first lens is circular, the light emitting region 10 may also be formed in a circular shape. As another example, if the effective region of the first lens has an elliptical or a circular shape, partially cut on both sides, the light transmitting region 10 may be formed in an elliptical shape. However, the shape of the light transmitting region 10 is not limited to the shape of the effective region of the first lens. For example, the light emitting region 10 may be formed in a circular shape regardless of the shape of the effective region.

The light shielding region 12 may be formed on the incident surface 110 except for the light transmitting region 10. The light shielding region 12 may be formed by a light shielding film, a light shielding paint, or the like. The light shielding region 12 formed as described above may reduce a phenomenon in which light necessary for photographing is incident or reflected through the incident surface 110.

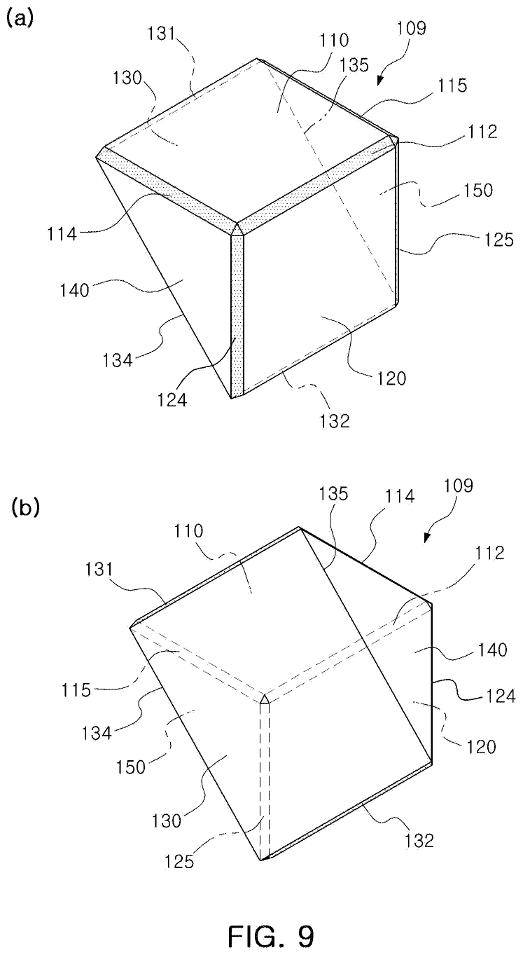

A prism for an optical imaging system according to an eighth embodiment will be described with reference to FIG. 8.

A prism 108 according to the present embodiment has a rectangular parallelepiped or a cubic shape bisected in a diagonal direction. The prism 108 includes three surfaces of a square shape and two surfaces of a triangular shape. For example, an incident surface 110, a light emitting surface 120, and a reflective surface 130 of the prism 108 are rectangular, and both side surfaces of the prism 108 are triangular.

The prism 108 may include one or more chamfered regions. For example, as shown in FIG. 8, a portion 112 where the incident surface 110 and the light emitting surface 120 are connected may be processed to be obtuse with respect to the incident surface 110 or the light emitting surface 120.

[The portion 112 may be formed not to cause a flare phenomenon. As an example, a light shielding film may be attached to the portion 112 or the portion 112 may be painted with a light shielding paint. As another example, the portion 112 may be processed into a form having a roughness so that scattering of light can be achieved.

In addition, the prism 108 according to the present embodiment may be configured to limit a light emitting region. For example, as shown in FIG. 8, the light emitting surface 120 of the prism 108 may include a light transmitting region 20 capable of transmitting incident light and a light shielding region 22 capable of blocking incident light.

The light transmitting region 20 may be formed to be substantially the same or similar to the cross-sectional shape of a lens constituting the optical imaging lens system. Specifically, the light transmitting region 20 may be formed to be the same or similar to an effective region of a lens (hereinafter, referred to as a first lens) disposed closest to an object side in the optical imaging system. As an example, if the effective region of the first lens is circular, the light transmitting region 20 may also be formed in a circular shape. As another example, if the effective region of the first lens has an elliptical or a circular shape, partially cut at both ends, the light transmitting region 20 may be formed in an elliptical shape. However, the shape of the light transmitting region 20 is not limited to the shape of the effective region of the first lens. For example, the light transmitting region 20 may be formed in a circular shape regardless of the shape of the effective region of the first lens.

The light shielding region 22 may be formed on a portion of the light emitting surface 120 except for the light transmitting region 20. The light shielding region 22 may be formed by a light shielding film, a light shielding paint, or the like. The light shielding region 22 formed as described above may reduce a phenomenon in which light unnecessary for photographing is emitted or reflected through the light emitting surface 120.

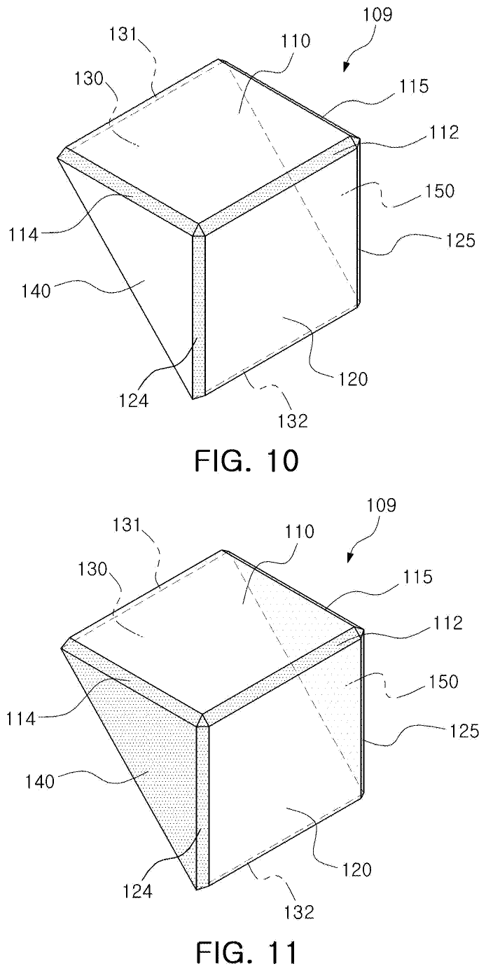

A prism for an optical imaging system according to a ninth embodiment will be described with reference to FIGS. 9 to 12.

A prism 109 according to the present embodiment generally has a rectangular parallelepiped or cubic shape bisected in a diagonal direction. The prism 109 includes three surfaces of a square and two surfaces of a triangle. For example, the incident surface 110, the light emitting surface 120, and the reflective surface 130 of the prism 109 are rectangular, and both side surfaces of the prism 109 are triangular.

The prism 109 according to the present embodiment includes a plurality of chamfered regions. For example, all corner portions of the prism 109 can be processed to be obtuse with respect to neighboring surfaces. In detail, portions 112, 114, and 115 connecting the incident surface 110, both side surfaces 140, 150, and the light emitting surface 120 are processed to be obtuse with respect to the incident surface 110. In addition, portions 124 and 125 connecting the light emitting surface 120 and both side surfaces 140 and 150 are processed to be obtuse with respect to the light emitting surface 120. In addition, portions 131 and 132 connecting the reflective surface 130 and the incident surface 110 and the light emitting surface 120, respectively, are processed to be obtuse with respect to the reflective surface 130. Optionally, portions 134 and 135 connecting the reflective surface 130 and both side surfaces 140 and 150 may also be processed to be obtuse with respect to the reflective surface 130.

The portions 112, 114, 115, 124, 125, 131, 132, 134, and 135 processed to be obtuse with respect to the incident surface 110, the light emitting surface 120, and the reflective surface 130 may be formed so as to not cause a flare phenomenon. As an example, a light shielding film may be attached to the portions 112, 114, 115, 124, 125, 131, 132, 134, and 135, or the portions 112, 114, 115, 124, 125, 131, 132, 134, and 135, may be painted with a light shielding paint. As another example, the portions 112, 141, 151, 124, 125, 131, 132, 134, and 135 may be processed into a form having a roughness so that scattering of light can be achieved.

In addition, the prism 109 according to the present embodiment may be configured to block incident light through a side surface. As an example, as illustrated in FIG. 11, a light shielding film may be attached to a first side surface 140 and a second side surface 150 of the prism 109 or a first side surface 140 and a second side surface 150 of the prism 109 may be painted with a light shielding paint. As another example, the first side 140 and the second side surface 150 of the prism 109 may be processed in a form having a roughness so that scattering of light can be achieved.

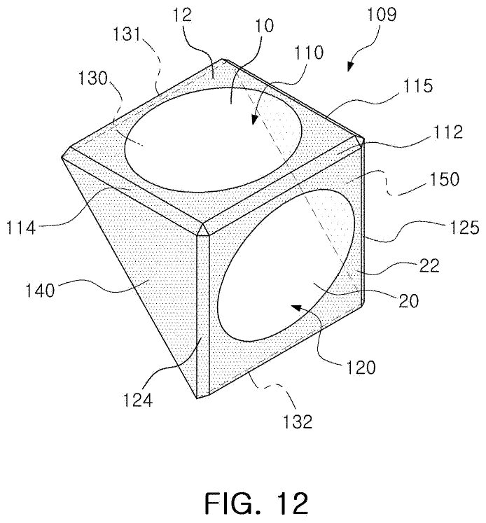

In addition, the prism 109 according to the present embodiment may be configured to limit a light emitting region. For example, the incident surface 110 and the light emitting surface 120 of the prism 109, as shown in FIG. 12, may include light transmitting regions 10 and 20 capable of transmitting incident light and light shielding regions 12 and 22 capable of blocking incident light.

The light transmitting regions 10 and 20 may be formed substantially the same or similar to the cross-sectional shape of the lenses constituting the optical imaging system. Specifically, the light transmitting regions 10 and 20 may be formed to be the same or similar to an effective region of a lens (hereinafter referred to as a first lens) disposed closest to an object side in the optical imaging system. As an example, if the effective region of the first lens is circular, the light transmitting regions 10 and 20 may also be formed in a circular shape. As another example, if the effective region of the first lens is an ellipse or a circular shape, partially cut at both ends, the light transmitting regions 10 and 20 may be formed in an elliptical shape. However, the shape of the light transmitting regions 10 and 20 is not limited to the shape of the effective region of the first lens. As an example, the light transmitting regions 10 and 20 may be formed in a circular shape regardless of the shape of the effective region of the first lens.

The light transmitting region 10 of the incident surface 110 and the light transmitting region 20 of the light emitting surface 120 may have different sizes. For example, the second light transmitting region 20 may be smaller than the first light transmitting region 10. The second light transmitting region 20 formed as described above may function as an aperture for adjusting an amount of light toward a lens side. Therefore, the shape of the prism as described above can omit the configuration of the aperture.

The light shielding regions 12 and 22 may be formed on a portion of the incident surface 110 and the light emitting surface 120, respectively, except for the light transmitting regions 10 and 20. The light shielding regions 12 and 22 may be formed of a light shielding film, a light shielding paint, or the like. The light shielding regions 12 and 22 formed as described above may reduce a phenomenon in which light unnecessary for photographing is incident, emitted, or reflected through the incident surface 110 and the light emitting surface 120.

As set forth above, according to the present disclosure, a phenomenon in which a part or all of a prism is damaged by external impacts may be reduced.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A prism for an optical imaging system, comprising:
an incident surface;
an emitting surface from which light is emitted; and
a reflective surface reflecting light incident through the incident surface to the emitting surface,
wherein at least one connection portion of the incident surface and the emitting surface is chamfered to form a surface.

2. The prism of claim 1, wherein the at least one connection portion comprises a first connection surface, to which the incident surface and the emitting surface are connected, formed to have an obtuse angle with respect to the incident surface and the emitting surface, respectively.

3. The prism of claim 1, wherein the at least one connection portion comprises a second connection surface, at which one or more of the incident surface and the reflective surface are connected and the emitting surface and the reflective surface are connected, formed to have an obtuse angle with respect to the reflective surface.

4. The prism of claim 1, wherein the incident surface and the emitting surface are each configured to have a wavefront aberration different from that of the reflective surface.

5. The prism of claim 4, wherein the wavefront aberration of the incident surface and the wavefront aberration of the emitting surface are each greater than a reflective aberration of the reflective surface.

6. The prism of claim 1, wherein an antireflective layer is formed on the incident surface and the emitting surface.

7. The prism of claim 1, wherein an antireflective layer and an infrared blocking layer are formed on the reflective surface.

8. The prism of claim 1, wherein the surface of the connection portion comprises one or more of a light shielding paint, a light shielding film, and a light-scattering roughness to prevent a flare phenomenon.

9. The prism of claim 1, wherein the incident surface comprises a first light transmitting region capable of transmitting incident light and a first light shielding region capable of blocking incident light.

10. The prism of claim 9, wherein the emitting surface comprises a second light transmitting region capable of transmitting incident light and a second light shielding region capable of blocking incident light.

11. The prism of claim 10, wherein the second light transmitting region is formed to be smaller than the first light transmitting region.

12. The prism of claim 1, wherein the at least one connection portion comprises a third connection surface connecting the incident surface and a side surface, and configured to have an obtuse angle with respect to the incident surface.

13. The prism of claim 1, wherein the at least one connection portion comprises a fourth connection surface connecting the emitting surface and a side surface, and configured to have an obtuse angle with respect to the emitting surface.

14. An optical imaging system, comprising:
a lens comprising an effective region to refract incident light on an optical path reflected from an object; and
a prism configured to bend the optical path and comprising:
an incident surface;
a reflective surface;
a light emitting surface; and
two side surfaces spaced apart from each other by the incident surface, the reflective surface, and the light emitting surface,
wherein one or more corners of the prism comprise a chamfered region, and
wherein the chamfered region comprises one or more of a light shielding film, a light shielding paint, and a light-scattering roughness.

15. The optical imaging system of claim 14, wherein the two side surfaces comprise one or more of a light shielding film, a light shielding paint, and a light-scattering roughness.

16. The optical imaging system of claim 14, wherein one or more of the incident surface and the light emitting surface comprises a light shielding region capable of blocking incident light and a light transmitting region capable of transmitting incident light, and
wherein the light shielding region surrounds the light transmitting region.

17. The optical imaging system of claim 14, wherein the incident surface and the emitting surface are each configured to have a wavefront aberration different from that of the reflective surface.

18. The optical imaging system of claim 14, wherein the incident surface, the light emitting surface, and the reflective surface comprise a predetermined wavefront aberration.

19. A prism for an optical imaging system, comprising:
an incident surface;
a reflective surface; and
a light emitting surface,
wherein one or more of the incident surface and the light emitting surface comprises a light shielding region capable of blocking incident light and a light transmitting region capable of transmitting incident light,
wherein one or more corners of the prism where any two of the incident surface, the reflective surface, and the light emitting surface meet, comprises a chamfered region comprising a light-blocking or light-scattering surface.

20. The prism of claim 19, wherein the prism comprises a rectangular parallelepiped bisected in a diagonal direction,
wherein the incident surface, the reflective surface, and the light emitting surface are rectangular, and
wherein two sides spaced apart from each other by the incident surface, the reflective surface, and the light emitting surface are triangular and each of the two sides comprises a light-blocking or light-scattering surface.
